(19) United States
(12) Patent Application Publication
(10) Pub. No.: US 2026/0357832 A1
(43) Pub. Date: Nov. 12, 2026

(54) CLIP

(71) Applicant: NIFCO INC., Yokosuka-shi, Kanagawa (JP)

(72) Inventor: Takehiro SATO, Yokosuka-shi, Kanagawa (JP)

(21) Appl. No.: 19/139,370

(22) PCT Filed: Nov. 8, 2023
(86) PCT No.: PCT/JP2023/040210

§ 371 Date: Jun. 16, 2025

(30) Foreign Application Priority Data
Jan. 27, 2023 (JP) 2023-010808

(51) Int. Cl. F16B 2/18

(52) U.S. Cl. CPC F16B 2/18

(57) ABSTRACT

A clip is attached to an attached bolt to fasten an attached member, in which the attached bolt fixed to a mounting surface is inserted, to the mounting surface. The clip includes a body in which an insertion path into which the attached bolt is to be inserted is formed, a claw located in the insertion path and configured to engage with the attached bolt, and a fixture attached to the body. The clip is configured to be deformed into a detached posture in which the fixture is separated from the attached member, or a fixed posture in which the fixture is pressed against the attached member and the body is pushed in a direction to be separated from the attached member.

### FIELD

The present invention relates to a clip that is attached to a stud bolt or the like.

### BACKGROUND

Conventionally, for example, when insulators and other components are attached under the floor of an automobile, or when liners and other components are attached to wheel wells, fastening structures using stud bolts and nuts are used. For example, a stud bolt is provided in the body of the automobile, and the stud bolt is tightened by a nut while passing through attached members, such as an insulator and a liner. For example, in the invention described in Patent Literature 1 below (hereinafter, referred to as the “Literature Known 1 Invention”), a plastic clip is used instead of a nut.

The clip according to the Literature Known 1 Invention includes a cylinder in which a hole is formed to insert a stud bolt, and a flexible arm is formed on a portion of a side surface of the cylinder by cutting out a portion of the side surface of the cylinder. A thread groove that screws with the stud bolt is formed on the inner surface of the flexible arm.

A swingable crotch piece is connected to the upper end of the cylinder, and the swingable crotch piece swings from the connection point as a starting point. The swingable crotch piece is crotched into two parts with a groove formed therebetween, and when the cylinder is caught in the groove, the flexible arm is sandwiched and held from outsides by the swingable crotch piece. The caught flexible arm bends inward and is pressed against the stud bolt inserted in the cylinder while being screwed to the stud bolt, thus attaching the clip to the stud bolt.

### CITATION LIST

### Patent Literature

Patent Literature 1: Japanese Patent Application Laid-open Publication No. S63-280909

### SUMMARY OF THE INVENTION

### Technical Problem

However, in Literature Known 1 Invention, the thread groove formed on the inner surface of the flexible arm does not always match a size of the thread groove of the stud bolt, and may not fit to the pitch of the thread groove of the stud bolt. In that case, the clip is attached to the stud bolt with a gap between the clip and an attached member, causing the attached member to rattle in the gap. Therefore, the clip may need to be tightened again.

The present invention has been made in view of such circumstances. It is an object of the present invention to provide a clip that can be fastened to a mounting surface without allowing the attached member to rattle. In a broader sense, it is an object of the present invention to reduce emission of harmful substances and maintain a comfortable environment, which is a universal issue.

### Solution to Problem

In order to achieve the object described above, a clip according to the present invention is a clip to be attached to an attached bolt to fasten an attached member, in which the attached bolt fixed to the mounting surface is inserted, to a mounting surface, the clip being characterized in including a body in which an insertion path into which the attached bolt is to be inserted is formed, a claw that is located in the insertion path and engages with the attached bolt, and a fixture attached to the body, in which the clip is deformed into a detached posture in which the fixture is separated from the attached member, or a fixed posture in which the fixture is pressed against the attached member and the body is pushed in a direction to be separated from the attached member.

The clip according to the present invention is characterized in that a pressing end of the fixture that touches the attached member in the fixed posture projects toward the attached member beyond a body end of the body that is in contact or in proximity to the attached member in the detached posture.

The clip according to the present invention is characterized in that the body is connected in advance to the fixture with a rotary shaft interposed therebetween.

The clip according to the present invention is characterized in that the body is connected to the fixture with a rail structure interposed therebetween, and the fixture moves along the rail structure.

The clip according to the present invention is characterized in that the body fits with the fixture in the fixed posture.

The clip according to the present invention is characterized in having an outer shape to be restricted from rotating about the attached bolt as an axis of rotation, by contacting a limiter formed around the attached bolt.

The clip according to the present invention is characterized in that the body includes a side on which the insertion path is formed, and the body end formed at an end on an entrance side of the insertion path; the side includes the claw formed on an inner surface of the side, a rotary shaft formed on an outer surface of the side, a rail groove formed around the rotary shaft on the outer surface of the side, and a fitting projection formed around the rotary shaft on the outer surface of the side; the fixture includes an arm that is supported by the rotary shaft and faces the outer surface of the side, and a lever that is connected to the arm and projects beyond the body; and the arm includes the pressing end formed at an edge of the arm, a rail projection that is formed on an inner surface of the arm along the rail groove; and a fitting hole that is formed on the inner surface of the arm and fits with the fitting projection.

### Advantageous Effects of Invention

A clip according to the present invention is a clip configured to be attached to an attached bolt to fasten an attached member, in which the attached bolt fixed to the mounting surface is inserted, to a mounting surface. The clip includes a body in which an insertion path into which the attached bolt is to be inserted is formed, a claw that is located in the insertion path and engages with the attached bolt, and a fixture attached to the body. The clip is deformed into a detached posture in which the fixture is separated from the attached member, or a fixed posture in which the fixture is pressed against the attached member and the body is pushed in a direction to be separated from the attached member. In the detached posture, when the attached bolt is inserted into the insertion path of the body, the claw engages the attached bolt. While the claw engages with the attached bolt, when the clip is deformed into the fixed posture, the fixture is pressed against the attached member and the body is pushed in a direction away from the attached member. Therefore, in the detached posture, even if the claw does not fit to the pitch of a thread groove of the attached bolt or if a gap is present between the body and the attached member, the fixture pushes the attached member and the body in directions to separate them, thereby engaging the claw with the thread groove so as to fit to the pitch of the thread groove. Therefore, the attached member can be fastened to the mounting surface without rattling.

In the clip according to the present invention, a pressing end of the fixture that touches the attached member in the fixed posture projects toward the attached member beyond the body end of the body that is in contact or in proximity with the attached member in the detached posture. With this configuration, in the detached posture, the body end is in contact (or in proximity) with the attached member, and when the clip is deformed into the fixed posture, the pressing end touches the attached member. That is, the degree of projection (hereinafter, referred to as “protrusion amount”) of the pressing end with respect to the attached member is greater than that of the body end. Therefore, when the pressing end is pressed against the attached member in the fixed posture, the body end is separated from the attached member and the body is pushed away from the attached member in the direction away from the attached member by an amount equivalent to the difference in the projection amount. Thus, the attached member can be fastened to the mounting surface without rattling.

In the clip according to the present invention, the body is connected to the fixture in advance with a rotary shaft interposed therebetween. This configuration smooths the deformation into the detached posture or the fixed posture.

Thus, the fixture is easy to operate, and the operation of the fixture is stabilized.

In the clip according to the present invention, the body is connected to the fixture with a rail structure interposed therebetween, and the fixture moves along the rail structure.

During the deformation into the detached posture or the fixed posture, the friction by the rail structure stops the fixture in any posture with respect to the body, preventing the fixture from moving unintentionally. In addition, the fixture operates along the rail structure, thus being easy to operate.

In the clip according to the present invention, the body fits with the fixture in the fixed posture. Therefore, the fixed posture is robust. In addition, a user can be given a sense of crispness (click feel) that the fixed posture has been achieved.

The clip according to the present invention has an outer shape to be restricted from rotating about the attached bolt as an axis of rotation, by contacting a limiter formed around the attached bolt. That is, while the clip may rotate about the attached bolt as an axis of rotation, the rotation is restricted by the contact of the clip with the limiter. Thus, the clip is restrained from unintentionally coming off the attached bolt.

In the clip according to the present invention, the body includes a side on which the insertion path is formed and the body end formed at an end on an entrance side of the insertion path; the side includes the claw formed on an inner surface of the side, the rotary shaft formed on an outer surface of the side, a rail groove formed around the rotary shaft on the outer surface of the side, and a fitting projection formed around the rotary shaft on the outer surface of the side; the fixture includes an arm that is supported by the rotary shaft and faces the outer surface of the side, and a lever that is connected to the arm and projects beyond the body; and the arm includes the pressing end formed at an edge of the arm, a rail projection that is formed on an inner surface of the arm and fits along the rail groove, and a fitting hole that is formed on the inner surface of the arm and fits with the fitting projection. Therefore, the attached member can be fastened to the mounting surface without rattling.

### BRIEF DESCRIPTION OF THE DRAWINGS

FIG. 1 is a perspective view of a clip according to an embodiment of the present invention in a detached posture.

FIG. 2 is a perspective view of the clip according to the embodiment of the present invention in a fixed posture.

FIG. 3 is a first perspective view of a body of the clip according to the embodiment of the present invention.

FIG. 4 is a second perspective view of the body of the clip according to the embodiment of the present invention.

FIG. 5 is a right side view of the body of the clip according to the embodiment of the present invention.

FIG. 6 is a back side view of the body of the clip according to the embodiment of the present invention.

FIG. 7 illustrates a section along VII-VII in FIG. 6, and is a left side sectional view of the body of the clip according to the embodiment of the present invention.

FIG. 8 is a perspective view of a fixture of the clip according to the embodiment of the present invention.

FIG. 9 is a right side view of the fixture of the clip according to the embodiment of the present invention.

FIG. 10 illustrates a section along X-X in FIG. 8, and is a right side sectional view of the fixture of the clip according to the embodiment of the present invention.

FIG. 11 is a right side view of the clip according to the embodiment of the present invention in the detached posture.

FIG. 12 is a back side view of the clip according to the embodiment of the present invention in the detached posture.

FIG. 13 is an upward view of the clip according to the embodiment of the present invention in the detached posture.

FIG. 14 is a downward view of the clip according to the embodiment of the present invention in the detached posture.

FIG. 15 is a right side view of the clip according to the embodiment of the present invention in the fixed posture.

FIG. 16 is a front side view of the clip according to the embodiment of the present invention in the fixed posture.

FIG. 17 is a first explanatory view illustrating a use procedure and a state of operation of the clip according to the embodiment of the present invention.

FIG. 18 is a second explanatory view illustrating the use procedure and a state of the operation of the clip according to the embodiment of the present invention.

FIG. 19 is a third explanatory view illustrating the use procedure and a state of the operation of the clip according to the embodiment of the present invention.

FIG. 20 is a sectional third explanatory view illustrating the use procedure and the state of the operation of the clip according to the embodiment of the present invention.

FIG. 21 is a fourth explanatory view illustrating the use procedure and a state of the operation of the clip according to the embodiment of the present invention.

FIG. 22 is a sectional fourth explanatory view illustrating the use procedure and the state of the operation of the clip according to the embodiment of the present invention.

FIG. 23 is a fifth explanatory view illustrating the use procedure and a state of the operation of the clip according to the embodiment of the present invention.

FIG. 24 is a sectional fifth explanatory view illustrating the use procedure and the state of the operation of the clip according to the embodiment of the present invention.

FIG. 25 is a sixth explanatory view illustrating the use procedure and a state of the operation of the clip according to the embodiment of the present invention.

### DESCRIPTION OF EMBODIMENTS

A clip according to an embodiment of the present invention is used to fasten an attached member to a mounting surface in the exterior or interior of a vehicle, such as an automobile. For example, a stud bolt serving as an attached bolt is melted and bonded by welding or the like to a body or a bracket serving as the mounting surface, and in a state in which the stud bolt is inserted in the attached member, such as an insulator, a liner, or a console box, the clip according to the present embodiment is attached to fasten the attached member to the mounting surface. Since the clip according to the present embodiment is used for any exterior and interior parts of the vehicle, the mounting surface and attached member are not limited to particular types.

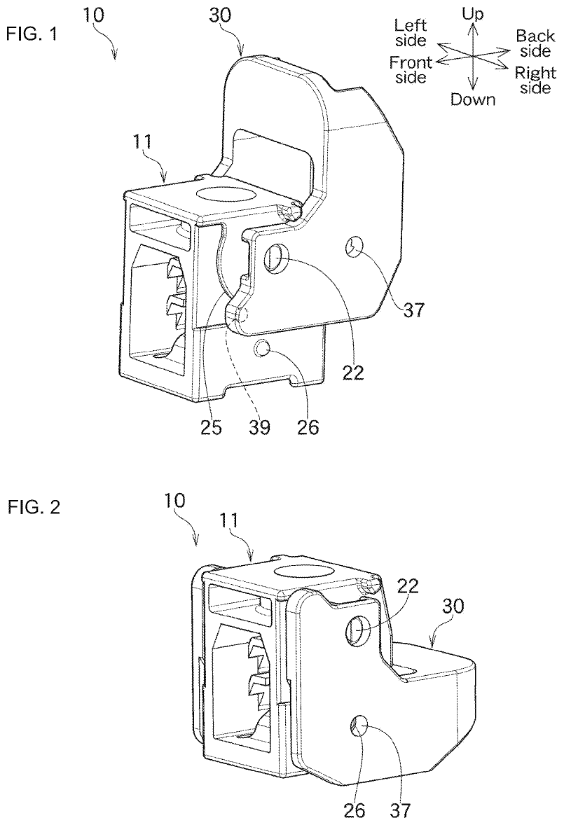

The following describes the clip according to the present embodiment based on the drawings. FIGS. 1 and 2 illustrate external appearances of a clip 10 according to the present embodiment. In the following description, “down” denotes a direction in which the clip 10 is inserted and attached to the stud bolt; “up” denotes a direction in which the clip 10 is pulled and removed from the stud bolt; and “right side”, “left side”, “front side”, and “back side” denote other directions (refer to FIG. 1).

In FIGS. 1 and 2, the clip 10 includes two members: a body 11 and a fixture 30. The body 11 and the fixture 30 are connected in advance with a rotary shaft 22 of the body 11 interposed therebetween, and the posture of the clip 10 changes as the fixture 30 rotates within a predetermined range with respect to the body 11. The body 11 and the fixture 30 are connected with a rail structure (rail projection 39 and body rail groove 25) interposed therebetween. Thus, the fixture 30 rotates along the rail structure when the posture of the clip 10 changes.

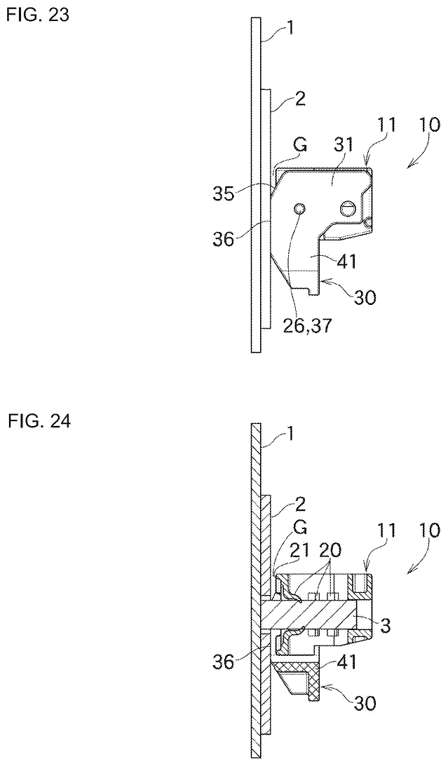

A detached posture refers to a state in which the fixture 30 is raised as illustrated in FIG. 1. In the detached posture, the fixture 30 is separate from an attached member 2 (refer to FIG. 18). In contrast, a fixed posture refers to a state in which the fixture 30 is lowered as illustrated in FIG. 2. In the fixed posture, the fixture 30 is pressed against the attached member 2 (see FIG. 23). In the fixed posture, the body 11 is fitted with the fixture 30 with a fitting structure (fitting projection 26 and fitting hole 37) interposed therebetween.

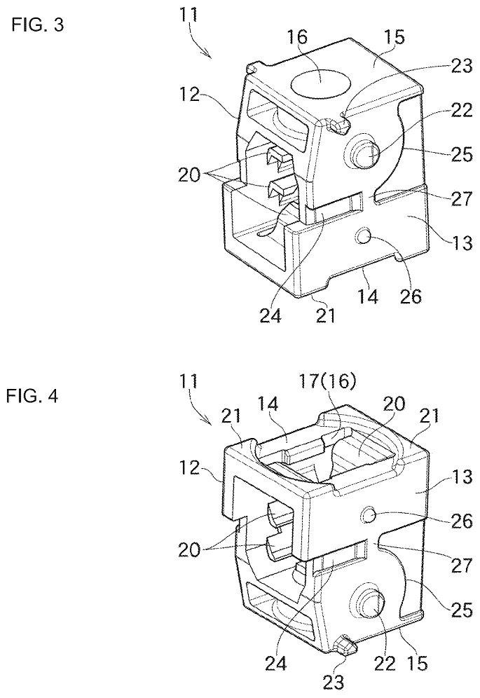

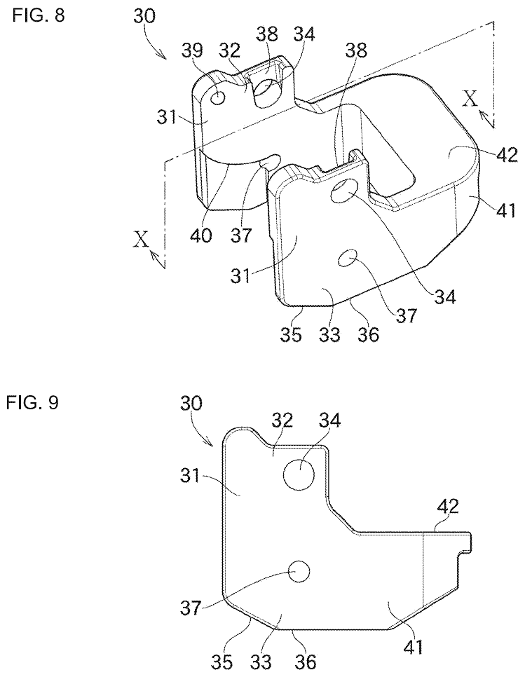

The following describes in detail the body 11 and the fixture 30 based on the drawings thereof. FIGS. 3 to 7 illustrate the body 11. FIGS. 8 to 10 illustrate the fixture 30.

As illustrated in FIGS. 3 to 7, the body 11 is substantially a rectangular solid or a cube and hollow. In the body 11, an insertion path 16 into which the stud bolt 3 is to be inserted is formed so as to span from the top to the bottom. A plurality of claws 20 to engage with a threaded groove of the stud bolt 3 is arranged in the insertion path 16.

In detail, the body 11 has plate-shaped right and left sides 12 and 13 that face each other and form right and left sides of the body 11, a bottom 14 that is connected to lower ends of the right and left sides 12 and 13 and forms the bottom of the body 11, and a top 15 that is connected to upper ends of the right and left sides 12 and 13 and forms the top of the body 11. The insertion path 16 is formed between the right and left sides 12 and 13, and the insertion path 16 includes an entrance side insertion path 17 formed at the bottom 14 and serving as an entrance for the stud bolt 3, an intermediate insertion path 18 formed in a space between the right and left sides 12 and 13 above the entrance side insertion path 17, and a tubular exit side insertion path 19 connected to the inner surface of the top 15 above the intermediate insertion path 18 (refer to FIG. 7).

The claws 20 are formed at front and rear edges of the entrance side insertion path 17 (refer to FIG. 4). The claws 20 project toward the inside of the body 11 (refer to FIG. 7). In the intermediate insertion path 18, the claws 20 formed on the inner surfaces of the right and left sides 12 and 13 project toward the inside of the body 11. The respective claws 20 are arranged at staggered levels in the up-down direction (refer to FIGS. 6 and 7).

At the bottom 14 of the body 11, a body end 21 is formed around the entrance side insertion path 17 (refer to FIG. 4). The body end 21 is a portion of the edge of the bottom 14 that projects downward.

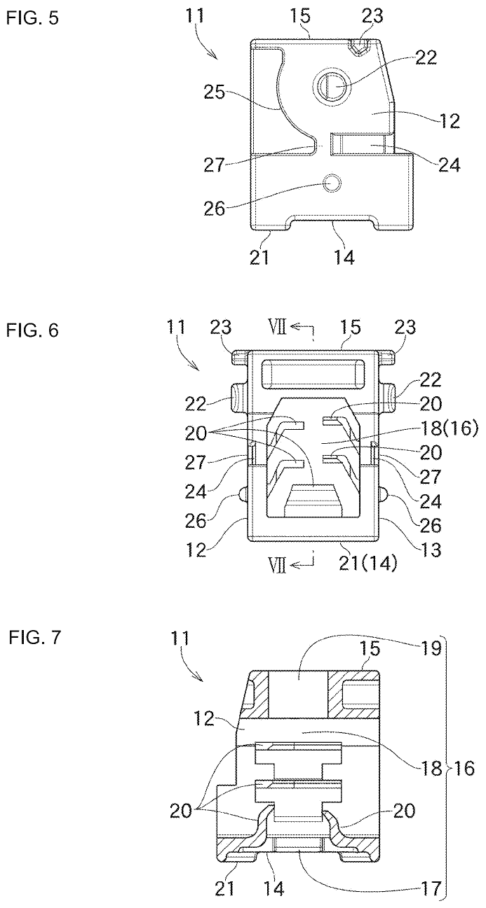

Outer surfaces of the right and left sides 12 and 13 include the rotary shaft 22, a rotation limiter 23 formed around the rotary shaft 22, a body guide groove 24, the body rail groove 25, and the fitting projection 26 (refer to FIG. 5). Each of the elements 22, 23, 24, 25, and 26 is a right-left pair. The rotary shaft 22 is located near tops of the right and left sides 12 and 13, and projects outward from the body 11. The rotation limiter 23 is located above the rotary shaft 22 and at the upper ends of the right and left sides 12 and 13, and projects toward the outside of the body 11. The body guide groove 24 has a linear shape extending in front and back directions, and is located on a lower back side of the rotary shaft 22. The body rail groove 25 has an arc shape along a circumference centered on the rotary shaft 22, and is located in front of the rotary shaft 22. A portion between the body guide groove 24 and the body rail groove 25 is provided with no groove, and thus forms a step 27.

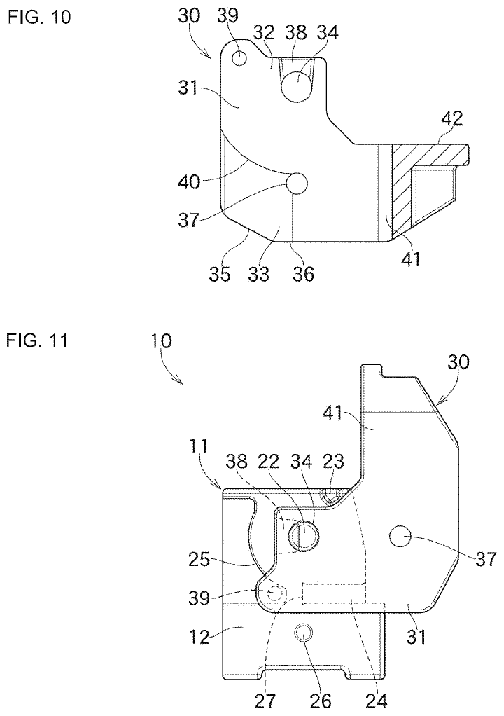

As illustrated in FIGS. 8 to 10, the fixture 30 includes plate-shaped arms 31 facing each other on the right and left sides, and a lever 41 connected to ends of the extended arms 31. The lever 41 includes a pressure plate 42. When viewed from the right and left sides, the fixture 30 has an L shape with the arms 31 intersecting the lever 41 at right angles (or approximately right angles) (refer to FIG. 9). Each of the arms 31 has a shaft hole 34 formed at one end 32 (upper end), a corner 35 and a pressing end 36 formed at an edge of another end 33 (lower end) that is a distal end of the arm 31 extended from the one end 32, and a fitting hole 37 formed between the shaft hole 34 and the pressing end 36. An arm guide groove 38, a rail projection 39, and an arm rail groove 40 are formed on the inner surface of the arm 31 (refer to FIG. 10). Each of the elements 34, 35, 36, 37, 38, 39, and 40 is a right-left pair.

As illustrated in FIGS. 9 and 10, the corner 35 is formed at an obtuse angle with respect to the pressing end 36. The shaft hole 34, the pressing end 36, and the fitting hole 37 are aligned in a straight line. The arm guide groove 38 has a linear shape extending outward from the one end 32 through the shaft hole 34. The rail projection 39 is formed at a location that surrounds the shaft hole 34 and projects outward from the one end 32 beyond the shaft hole 34. The arm rail groove 40 has an arc shape along a circumference centered on the shaft hole 34, and continues to the fitting hole 37.

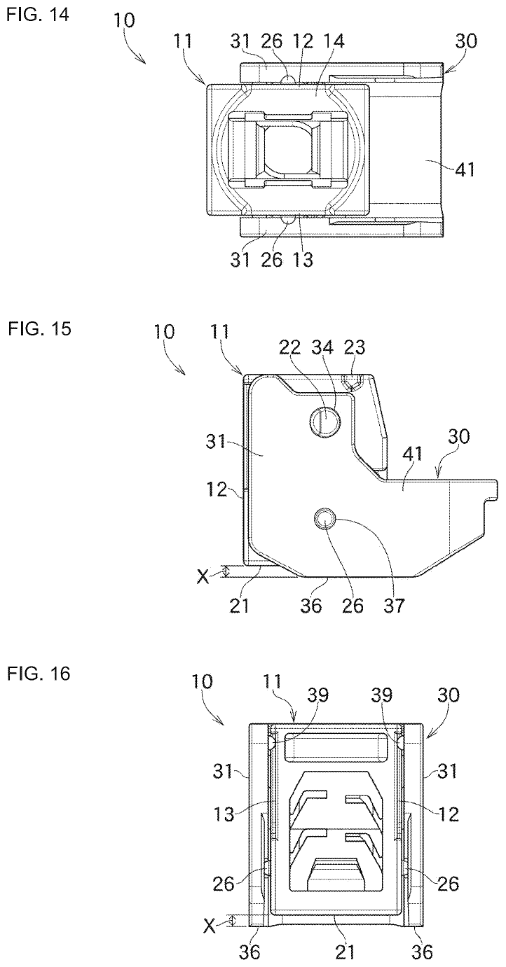

The body 11 and the fixture 30 configured as described above are connected as described below. FIGS. 11 to 16 each illustrate the clip 10 in an assembled state.

As illustrated in FIG. 11, the fixture 30 is attached to the body 11 from behind in a posture in which the arm 31 is located lower and the lever 41 is located upper. The fixture 30 is pressed against the body 11 with the rail projection 39 of the arm 31 being touched and guided by the body guide groove 24 of the body 11. When the rail projection 39 passes through the body guide groove 24 and overrides the step 27 of the body 11, the rotary shaft 22 of the body 11 is touched and guided by the arm guide groove 38 of the arm 31. The rail projection 39 is located in the body rail groove 25 of the body 11, and the rotary shaft 22 passes through the arm guide groove 38 and fits into the shaft hole 34 of the arm 31.

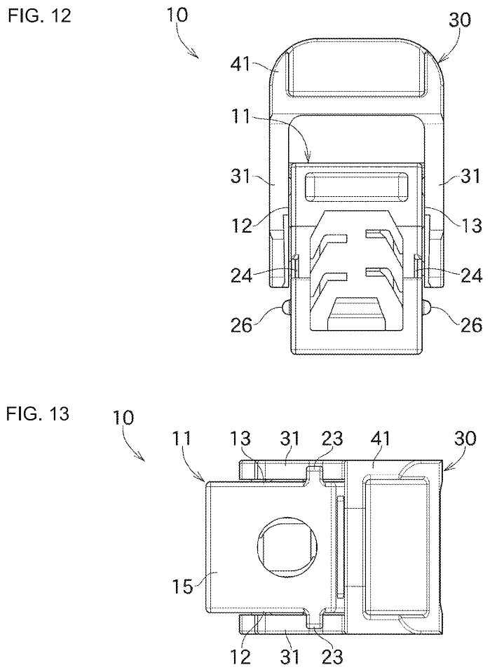

When the fixture 30 is attached to the body 11, the arm 31 is supported by the rotary shaft 22 of the body 11. As illustrated in FIGS. 12 to 14, the arms 31 face the outer surfaces of the right and left sides 12 and 13 of the body 11, and sandwich and hold the body 11. Immediately after the fixture 30 is attached to the body 11, the clip 10 is in the detached posture. In the detached posture, the fixture 30 is in contact with the rotation limiter 23, thus being restricted from rotating (rotating counterclockwise in FIG. 11).

The rail projection 39 of the arm 31 fits along the body rail groove 25 of the body 11 to form the rail structure (refer to FIG. 11), and the fitting projection 26 of the body 11 also fits along the arm rail groove 40 of the arm 31 (refer to FIG. 10) to form a rail structure. Therefore, rotating the fixture 30 brings the clip 10 into the fixed posture as illustrated in FIG. 15. In the fixed posture, the fitting projection 26 fits with the fitting hole 37. The lever 41 projects behind the body 11. As illustrated in FIG. 16, the body end 21 of the body 11 overlaps the pressing end 36 of the arm 31, but the pressing end 36 projects downward beyond the body end 21 by a projection amount X.

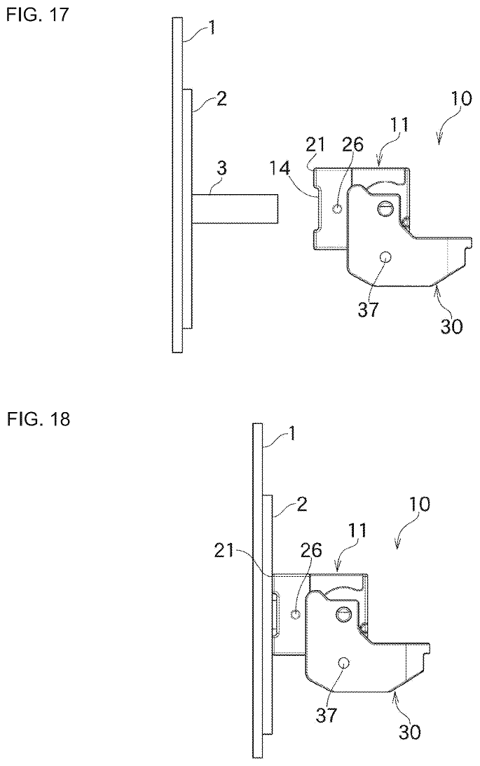

The clip 10 is configured as described above. The following describes a use procedure and states of operation of the clip 10, as well as effects of the present embodiment. FIGS. 17 to 24 illustrate the use procedure and processes of the operation of the clip 10.

As illustrated in FIG. 17, the stud bolt 3 is melted and bonded to a mounting surface 1, and the stud bolt 3 is inserted in the attached member 2. In this state, the clip 10 in the detached posture is attached to the stud bolt 3. The bottom 14 of the body 11 is directed toward the attached member 2, and the entrance side insertion path 17 of the insertion path 16 (refer to FIG. 4) is provided through the stud bolt 3.

As illustrated in FIG. 18, the clip 10 is pushed down until the body end 21 of the body 11 touches the attached member 2. Since the claws 20 are arranged in the insertion path 16 (refer to FIGS. 6 and 7), the claws 20 engage with the threaded groove of the stud bolt 3. At this time, the claws 20 engage with the threaded groove of the stud bolt 3 in the state in which the body end 21 touches the attached member 2. However, depending on the pitch of the threaded groove, the body end 21 may be slightly separated from the attached member 2 and the claws 20 may engage with the threaded groove of the stud bolt 3 while leaving a gap between the body end 21 and the attached member 2.

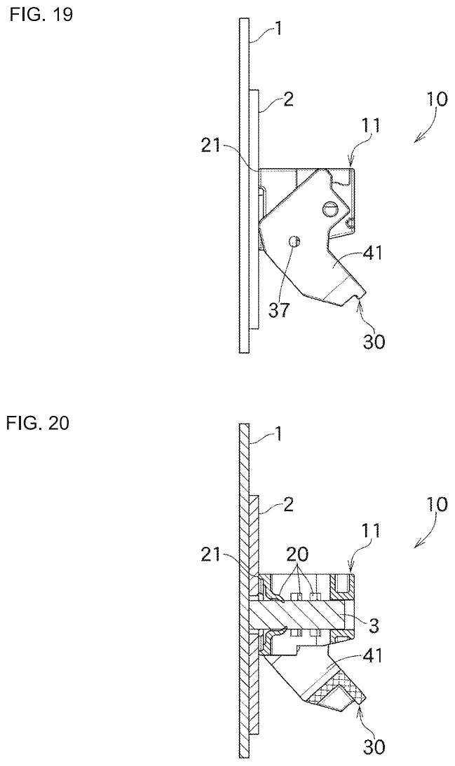

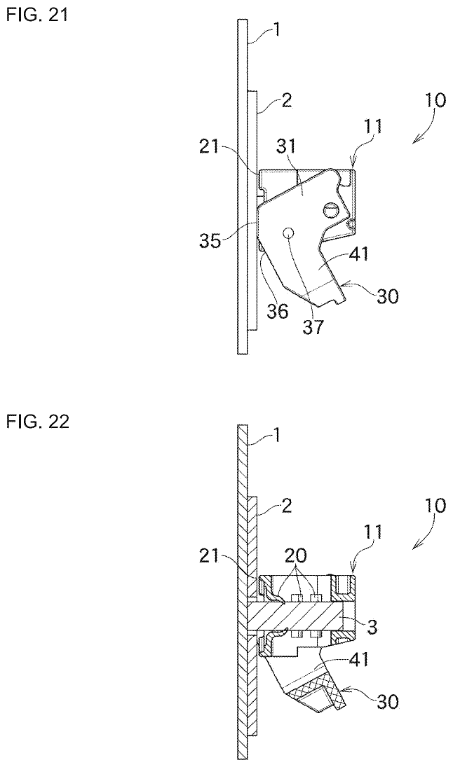

The fixture 30 rotates (clockwise in FIGS. 19 and 20) as illustrated in FIGS. 19 and 20, and the corner 35 of the arm 31 touches the attached member 2 as illustrated in FIGS. 21 and 22 and further, when the pressing end 36 of the arm 31 starts touching the attached member 2, the pressing end 36 is pressed against the attached member 2, so that the body 11 is pushed by the arm 31 in a direction away from the attached member 2. At that time, the arm 31 smoothly slides with respect to the attached member 2 because the corner 35 forms an obtuse angle with respect to the pressing end 36. As illustrated in FIGS. 23 and 24, when the fixture 30 further rotates and the clip 10 is deformed to the fixed posture, the pressing end 36 is pressed against the attached member 2, and the body 11 is separated from the attached member 2 by the arm 31 (refer to a gap G in FIGS. 23 and 24). That is, since the arm 31 pushes the attached member 2 and the body 11 in a direction to separate them, the claws 20 are engaged in a state of fitting to the pitch of the threaded groove. Therefore, the attached member 2 stays on the mounting surface 1 without rattling.

In detail, in the clip 10 in the detached posture, the body end 21 is in contact with (or close to) the attached member 2, and when the clip 10 is deformed to the fixed posture, the pressing end 36 touches the attached member 2, so that the projection amount X (degree of projection with respect to the attached member 2) of the pressing end 36 is larger than that of the body end 21 (refer to FIG. 16). Therefore, when the pressing end 36 is pressed against the attaching member 2 in the fixed posture, the body end 21 is separated from the attached member 2 by an amount equivalent to the difference in the projection amount X, and the body 11 is pushed in the direction away from the attached member 2.

Since the lever 41 is connected to the arm 31, the pressure plate 42 of the lever 41 is pushed when the fixture 30 is operated. As a result, operation by a user is made smoother. When the fixture 30 is attached to the body 11 in advance, the clip 10 is deformed by simply rotating the fixture 30 after the clip 10 is attached to the stud bolt 3. Therefore, the deformation to the detached posture or the fixed posture is made smoother. Therefore, good operability of the fixture 30 is achieved and the operation of the fixture 30 is stabilized.

The body rail groove 25 is formed on the outer surface of the body 11 (refer to FIG. 5), while the rail projection 39 is formed on the inner surface of the arm 31 (refer to FIG. 10). Therefore, the rail projection 39 fits along the body rail groove 25 to form the rail structure (refer to FIG. 11). Furthermore, the fitting projection 26 is formed on the outer surface of the body 11 (refer to FIG. 5), while the arm rail groove 40 is formed on the inner surface of the arm 31 (refer to FIG. 10). Therefore, the fitting projection 26 fits along the arm rail groove 40 to form the rail structure. Therefore, when the clip 10 is deformed to the detached posture or the fixed posture, friction by the rail structure stops the fixture 30 in any posture with respect to the body 11, so that the fixture 30 does not rotate unintentionally. In addition, the fixture 30 operates along the rail structure, which provides good operability.

The fitting projection 26 is formed on the outer surface of the body 11 (refer to FIG. 5); the fitting hole 37 is formed in the arm 31 (refer to FIG. 10); and the fitting projection 26 and the fitting hole 37 form the fitting structure (refer to FIG. 2). As a result, the fitting projection 26 fits in the fitting hole 37 in the fixed posture. Therefore, the fixed posture is robust. In addition, the user can be given a sense of crispness (click feel) that the fixed posture has been achieved.

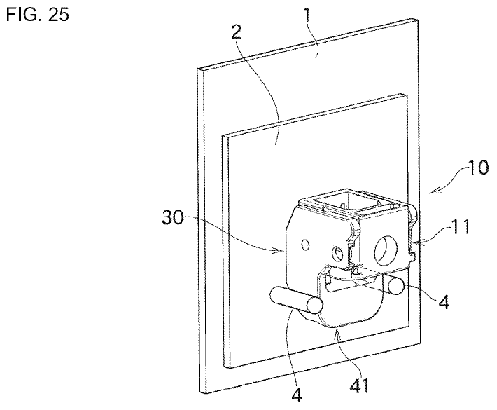

Since the stud bolt 3 is cylindrical with the threaded groove, the clip 10 may rotate with respect to the stud bolt 3. However, since the clip 10 has an external shape, such as the body 11 being a rectangular solid or a cube and the fixture 30 including the lever 41 projecting from the body 11, the rotation of the clip 10 is restricted by contacting the limiter 4 located around the stud bolt 3, as illustrated in FIG. 25. This configuration restrains the clip 10 from unintentionally coming off the stud bolt 3. In other words, a clip structure is formed by providing the limiter 4 on a trajectory of the clip 10 when rotating about the stud bolt 3 as the axis of rotation. As long as it is located on the trajectory of the clip 10 when rotating, the limiter 4 may have any one of the following configurations: a configuration formed on the attached member 2, a configuration formed on the mounting surface 1, and a configuration extending from a member other than the attached member 2 and the mounting surface 1 and arranged around the clip 10.

In another embodiment according to the invention, the body and the fixture are detachable, and the fixture is attached to the body after the body is attached to the stud bolt.

In still another embodiment, the fixture changes in posture not by rotating about the body, but by sliding linearly.

In still another embodiment, the projection amount is the same between the pressing end of the fixture and the body end of the body, or the projection amount of the body end is larger. In this case, a portion of the attached member where the pressing end is pressed projects by an amount equivalent to the difference in the projection amount.

In still another embodiment, the body rail groove is not formed on the body and the rail projection is not formed on the arm, so that no rail structure is included.

In still another embodiment, the fitting projection is not formed on the body and the fitting hole is not formed in the arm, so that the body does not fit with the fixture in the fixed posture.

In still another embodiment, the limiter is not included. In still another embodiment, the shaft hole is formed in the outer surface of the body, and the rotary shaft is formed on the arm of the fixture.

In still another embodiment, the fitting hole is formed in the body, and the fitting projection is formed on the arm of the fixture.

In still another embodiment, the body is cylindrical or polygonal prism-shape.

In still another embodiment, front and back sides are provided.

In still another embodiment, in the fixture, the arm intersects the lever at an acute angle or an obtuse angle when viewed from the right and left sides.

In still another embodiment, the fitting projection of the body and the fitting hole of the arm can be located in any positions as long as the body fits with the fixture in the fixed posture.

In still another embodiment, the corner is R-chamfered and has an arc shape.

In still another embodiment, the fixture includes no lever.

Although the embodiments of the present invention have been described in detail above, the present invention is not limited to the embodiments described above. The present invention can be modified in design in various ways as long as not deviating from the features described in the claims. The vehicles to which the embodiments of the present invention are attached also include, for example, trains, ships, aircraft, and so forth.

### REFERENCE SIGNS LIST

1 Mounting surface
2 Attached member
3 Stud bolt
4 Limiter
10 Clip
11 Body
12 Right side
13 Left side
14 Bottom
15 Top
16 Insertion path
17 Entrance side insertion path
18 Intermediate insertion path
19 Exit side insertion path
20 Claw
21 Body end
22 Rotary shaft
23 Rotation limiter
24 Body guide groove
25 Body rail groove (Rail structure)
26 Fitting projection (Fitting structure)
27 Step
30 Fixture
31 Arm
32 One end
33 Other end
34 Shaft hole
35 Corner
36 Pressing end
37 Fitting hole (Fitting structure)
38 Arm guide groove
39 Rail projection (Rail structure)
40 Arm rail groove
41 Lever
42 Pressure plate
G Gap
X Projection amount

1. A clip configured to be attached to an attached bolt to fasten an attached member, in which the attached bolt fixed to a mounting surface is inserted, to the mounting surface, the clip comprising:
a body in which an insertion path into which the attached bolt is to be inserted is formed;
a claw located in the insertion path and configured to engage with the attached bolt; and
a fixture attached to the body, wherein the clip is configured to be deformed into a detached posture in which the fixture is separated from the attached member, or a fixed posture in which the fixture is pressed against the attached member and the body is pushed in a direction to be separated from the attached member.

2. The clip according to claim 1, wherein a pressing end in the fixture that is configured to touch the attached member in the fixed posture is configured to project toward the attached member beyond a body end in the body that is in contact or in proximity to the attached member in the detached posture.

3. The clip according to claim 1, wherein the body and the fixture are connected in advance with a rotary shaft.

4. The clip according to claim 1, wherein the body and the fixture are connected with a rail structure, and the fixture moves along the rail structure.

5. The clip according to claim 1, wherein the body and the fixture are fit together in the fixed posture.

6. The clip according to claim 1, having an outer shape to restrict rotation about the attached bolt as an axis of rotation, by contacting a limiter formed around the attached bolt.

7. The clip according to claim 2, wherein
the body and the fixture are connected in advance with a rotary shaft,
the body comprises:
a side on which the insertion path is formed; and
the body end formed at an end on an entrance side of the insertion path, the side comprises:
the claw formed on an inner surface of the side;
the rotary shaft formed on an outer surface of the side;
a rail groove formed around the rotary shaft on the outer surface of the side; and
a fitting projection formed around the rotary shaft on the outer surface of the side, the fixture comprises:
an arm that is supported by the rotary shaft and faces the outer surface of the side; and
a lever that is connected to the arm and projects beyond the body, and the arm comprises:
the pressing end formed at an edge of the arm;
a rail projection that is formed on an inner surface of the arm along the rail groove; and
a fitting hole that is formed on the inner surface of the arm and fits with the fitting projection.
